(19) United States
(12) Patent Application Publication
(10) Pub. No.: US 2016/0241461 A1
(43) Pub. Date: Aug. 18, 2016

(54) Packet Rerouting Techniques in a Packet-Switched Communication Network

(71) Applicant: TELEFONAKTIEBOLAGET L M ERICSSON (PUBL), Stockholm (SE)

(72) Inventors: Gabor Sandor Enyedi, Budapest (HU); András Császár, Telki (HU)

(21) Appl. No.: 15/030,638

(22) PCT Filed: Oct. 21, 2014
(86) PCT No.: PCT/EP2014/072515

§ 371 Date: Apr. 20, 2016

Related U.S. Application Data
(60) Provisional application No. 61/893,446, filed on Oct. 21, 2013.

(51) Int. Cl. H04L 12/707; H04L 12/703; H04L 29/12; H04L 12/723

(52) U.S. Cl. CPC H04L 45/22; H04L 45/50; H04L 45/28; H04L 61/2007

(57) ABSTRACT

The present disclosure relates to preparation of nodes in a packet-switched communication network for enabling packet rerouting upon a failure in the network. The rerouting occurs along a detour defined by a Multiple Redundant Tree (MRT). A method aspect of this disclosure comprises computing, by a node of a set of connected nodes, at least one first MRT pair for a first MRT area to which a node is assigned. The first MRT area comprises a first subset of connected nodes. The method further comprises computing, by the node, at least one second MRT pair for a second MRT area to which the node is assigned. The second MRT comprises a second subset of the connected nodes.

### TECHNICAL FIELD

The present disclosure relates generally to rerouting techniques, including fast rerouting (FRR) procedures, for packet-switched communication networks. More particularly, the present disclosure relates to rerouting using multiple redundant trees (MRTs). The present disclosure may be implemented in the form of methods, apparatuses, networks, computer programs and data structures.

### BACKGROUND

Rerouting techniques, including Fast Rerouting (FRR) procedures, provide protection against link or node failures in both Internet Protocol (IP) and Multi-Protocol Label Switching (MPLS)/Label Distribution Protocol (LDP) networks. Protection in this context means that the network prepares in advance for failures by pre-computing alternate routes, also called detour routes or simply detours, that can be activated instantly when the failure occurs. In the case of IP-FRR, each node prepares for the failure of its connection with its immediate neighbour.

An FRR technique for IP networks currently being standardized by the Internet Engineering Task Force (IETF) uses Maximally Redundant Trees (MRTs) to provide FRR in the event of a failure. Details about FRR and MRTs can be found in the IETF document [I-D.ietf-rtgwg-mrt-frr-architecture] as defined at the end of the description.

In a typical IP network, each network node (e.g., router or switch), computes a shortest path to each destination and uses the shortest path for routing in non-failure conditions. For each destination, a pair of MRTs is also defined for protection purposes. Each tree in the pair of MRTs defines a path to a root node from any other network node. When a failure occurs along the shortest path, the affected network nodes will reroute traffic along a detour defined by one of the MRTs.

MRTs are pairs of directed spanning trees (a “red” tree and a “blue” tree in IETF terminology) that share a common root node and that are maximally redundant, meaning that that the paths along the two trees to the root node from any other network node have the fewest possible nodes and links in common. In a two-connected network, the paths along the two trees from any network node to the root node are node disjoint, while in a non-2-connected network, only the unavoidable cut nodes or cut links are common. Two MRTs can be found for any arbitrary root node in any set of connected network nodes.

Finding a “redundant pair” for the shortest path tree is not possible in general. Therefore, a pair of MRTs independent from shortest paths needs to be computed. When there is no failure, packets are forwarded along the shortest path. If a single failure occurs, it is guaranteed that at least one of the MRTs can still be used for forwarding packets. The network node detecting the failure can decide which tree to use, and forward the packet along that tree. After some period of time, the network will reconfigure and, following reconfiguration, packets can once again be forwarded along the new shortest paths.

Forwarding a packet along one of the MRTs is typically done by labeling the packet. For IP networks, each network node has two extra IP addresses describing the two MRTs. When a failure occurs, packets are put into an IP-in-IP tunnel and one of the extra addresses is inserted into the header of the tunneling packet. For MPLS/LDP networks, network nodes can allocate special MPLS labels to indicate that the packet is being forwarded along one of the MRTs. Further details about MRTs can be found in the IETF document [I-D.ietf-rtgwg-mrt-frr-architecture] and in the documents cited therein.

As a simple example, consider the network 10 shown in FIG. 1. The network 10 comprises a plurality of network nodes 15, such as routers or switches. An Interior Gateway Protocol (IGP) area 20 in the network 10 is defined. An IGP area 20 in this context is a part of the network, where all the routers have complete topology view, such as an Open Shortest Path First (OSPF) area or Intermediate System to Intermediate System (IS-IS) area. The network nodes 15 of the IGP area 20 are labeled respectively by the letters A-J, S and R. A pair of MRTs rooted at Node D is defined. Assume that some packets need to be sent from Node S to Node D. In this example, Node S is not necessarily the source node, but could be the ingress router in the IGP area 20. Similarly, Node D may be not the final destination, but could be an egress router in this IGP area 10.

If there is no failure, packets are forwarded along the shortest path to Node D. In the event of a link or node failure along the shortest path, packets may be forwarded along either the blue tree or the red tree to Node D. For example, assume that the link between Nodes C and D fails. In this example, Node C can send packets toward Node D along the blue tree rooted at Node D using the special IP address or MPLS label associated with the blue tree. When Node B receives the packet, it will also continue forwarding along the blue tree. The special IP address or MPLS label informs Node B that the packet needs to be forwarded along the blue tree. Otherwise, Node B would send the packet back to Node C using the shortest path.

As stated above, the MRTs in an MRT area provide detours that are not related to shortest paths. It has been found that although heuristics can be used to decrease the length of these detour paths, there is no guarantee that packets on the detour paths will be handled locally. In some instances, packets on a detour path may travel to portions of the network remote from the point of the failure. Such traffic may cause congestion even in remote parts of the network that were not otherwise impacted by the failure.

### SUMMARY

Accordingly, there is a need for techniques that permit an enhanced control of packet rerouting in a communication network.

According to one aspect, a method for preparing a node in a packet-switched communication network for enabling packet rerouting upon a failure is provided. The node belongs to a set of connected nodes in the network and the rerouting occurs along a detour defined by an MRT. The method is performed by the node and comprises computing at least one first MRT pair for a first MRT area to which the node is assigned, wherein the first MRT area comprises a first subset of the set of connected nodes. The method also comprises computing at least one second MRT pair for a second MRT area to which the node is assigned, wherein the second MRT area comprises a second subset of the set of connected nodes.

The method may also comprise receiving, by the node, configuration information. The configuration information may be indicative of the assignments of the node to the first MRT area (i.e., to the first subset of the set of connected nodes) and the second MRT area (i.e., to the second subset of the set of connected nodes).

The method may further comprise computing further MRT pairs for further MRT areas (and further subsets of the set of connected nodes) to which the node is assigned. As such, the node may be assigned to two, three or more MRT areas and may thus belong to two, three or more subsets of the set of connected nodes.

The first MRT area and the second MRT area may overlap at least partially. The overlap may comprise the node performing the above method aspect and, optionally, one or more further nodes of the set of connected nodes.

In one variant, the second subset fully comprises the first subset and at least a third subset of the set of connected nodes. The third subset may be constituted by one, more or all of the remaining nodes of the set of connected nodes. As such, the second subset may be associated with a global MRT area comprising the whole set of the connected nodes, while the first subset may be associated with a local MRT area smaller than the global MRT area (i.e., a proper subset of the set of connected nodes).

The term “local” as used herein may in certain variants denote a geographical attribute, meaning that the nodes in a local MRT area are geographically closer to each other than to the remaining nodes (e.g., in terms of a distance measure that relates to geographical coordinates). In other variants, the term “local” may not be used as a geographical attribute, but as a topological attribute. These variants can also be combined.

The method may further comprise selecting, upon a failure, one of the first MRT area and the second MRT pair. Out of the selected MRT pair an individual MRT may be selected in a further step for the actual packet rerouting. As an example, the first MRT pair may be selected (e.g., by default) upon a failure in the first MRT area. If the failure cannot be circumvented using the first MRT pair, the second MRT pair may be selected.

According to one implementation, at least one third MRT pair is computed for a third MRT area to which the node is assigned. The third MRT area may fully comprise the set of connected nodes. As such, the third MRT area may constitute a global MRT area, while both the first MRT area and the second MRT area may constitute local MRT areas.

Upon a failure in the first MRT area or the second MRT area, the first MRT pair or the second MRT pair, respectively, may be selected. Alternatively, if a failure in the first MRT area or the second MRT area cannot be circumvented using the respective MRT pair, the third MRT pair may be selected. As stated above, out of the selected MRT pair an individual MRT may be selected in a further step for rerouting purposes.

The set of connected nodes may be defined by an Interior Gateway Protocol (IGP) area. Also, the set of connected nodes may be defined by an MRT island.

At least one of the first MRT area and the second MRT area (and, optionally, the third or any further MRT area) may be defined by geographical locations of the connected nodes. Alternatively, or in addition, the MRT area definition may be performed via network topology information pertaining to the connected nodes. At least one of the first MRT area and the second MRT area (and, optionally, the third MRT area or any further MRT area) may be defined to handle failures locally. As explained above, the attribute “local” may be understood in terms of geographical locations (e.g., geographical coordinates), in terms of network topology information, or in terms of a combination thereof.

The method may further comprise advertising MRT area information using IGP and/or using MRT profiles. The MRT profiles for the first MRT area and the second MRT area, respectively, may advertise the same MRT capabilities and different profile identifiers. The node may maintain two dedicated Internet Protocol (IP) addresses or two dedicated Multi-Protocol Label Switching (MPLS) labels for each MRT area to which the node is assigned. These dedicated addresses or labels may be used to signal selection of an MRT pair or an individual MRT. The node may maintain one or more data structures that can be populated with the corresponding addresses and labels.

According to a further aspect, a method of assigning nodes in a packet-switched communication network to MRT areas for enabling packet rerouting upon a failure is provided. The nodes belong to a set of connected nodes in the network and the rerouting occurs along detours defined by MRTs. The method comprises assigning a node to a first MRT area, wherein the first MRT area comprises a first subset of the set of connected nodes. The method further comprises assigning the node to a second MRT area, wherein the second MRT area comprises a second subset of the set of connected nodes.

The method according to the second aspect may be performed by a computer or a computer system of a network operator. The assignments may be configured via that computer or computer systems at the respective nodes (e.g., via notification messages, operator settings, or otherwise).

Generally, the assignments may be performed based on at least one of geographical locations of the connected nodes and network topology information pertaining to the connected nodes. To this end, access to a database providing the geographical locations (e.g., in the form of geographical coordinates) and/or the network topology information may be provided for the assignment procedure.

The method according to the second aspect may further comprise configuring the node for advertising MRT area information using the IGP and/or MRT profiles. As an example, the node may be configured so that the MRT area profiles for the first MRT area and the second MRT area, respectively, advertise the same MRT capabilities and different profile identifiers.

Also provided is a computer program product comprising program code portions for performing the steps of any of the methods and method aspects presented herein when the computer program product is executed by one or more processors. The processors may be located in one or more of the connected network nodes and/or in the computer or computer system operated by a network operator. The computer program product may be stored on a computer-readable recording medium, such as a semiconductor memory, a hard disk or an optical disk. Also, the computer program product may be provided for download via a computer network.

A further aspect of the present disclosure is directed to a node in a packet-switched communication network that is enabled for packet rerouting upon a failure. The node belongs to a set of connected nodes in the network, and the rerouting occurs along a detour defined by an MRT. The node comprises at least one processor configured to compute at least one first MRT pair for a first MRT area to which the node is assigned, wherein the first MRT area comprises a first subset of the set of connected nodes, and to compute at least one second MRT pair for a second MRT area to which the node is assigned, wherein the second MRT area comprises a second subset of the set of connected nodes.

Still further, an apparatus for assigning nodes in a packet-switched communication network to MRT areas for enabling packet rerouting upon a failure is provided. The nodes belong to a set of connected nodes in the network and the rerouting occurs along detours defined by MRTs. The apparatus is configured to assign a node to a first MRT area, wherein the first MRT area comprises a first subset of the set of connected nodes, and to assign the node to a second MRT area, wherein the second MRT area comprises a second subset of the set of connected nodes.

The apparatus may be comprised by a computer or a computer system of a network operator. The computer or the computer system may be adapted to communicate with the connected nodes. Such a communication may be performed for configuration purposes (e.g., to inform the connected nodes about their respective assignments).

The node and the apparatus may be further configured to perform any of the methods and method aspects presented herein.

Also provided is a network that comprises multiple of the nodes and at least one apparatus as presented herein.

### BRIEF DESCRIPTION OF THE DRAWINGS

Further aspects, details and advantages of the present disclosure will become apparent from the following detailed description and the drawings. In the drawings,

FIG. 1 illustrates an example of MRTs for packet rerouting in a packet-switched communication network;

FIG. 2 illustrates an embodiment of network area assignments for MRT-based rerouting in a packet-switched communication network;

FIG. 3 illustrates local MRTs for the MRT areas illustrated in FIG. 2;

FIG. 4 illustrates another embodiment for assigning network nodes to MRT areas and also illustrates the associated MRTs;

FIG. 5 illustrates embodiments of a node and an apparatus in accordance with the present disclosure;

FIG. 6 illustrates method embodiments according to the present disclosure;

FIG. 7 illustrates a further method embodiment according to the present disclosure;

FIG. 8 shows a further network example;

FIG. 9 illustrates another embodiment of MRT area assignments; and

FIG. 10 illustrates a still further embodiment of MRT area assignments.

### DETAILED DESCRIPTION

In the following description, for purposes of explanation and not limitation, specific details are set forth, such as specific network types including particular network nodes, communication protocols, and so on, in order to provide a thorough understanding of the present disclosure. It will be apparent to one skilled in the art that the present disclosure may be practiced in other embodiments depart from these specific details. For example, the skilled artisan will appreciate that the present disclosure is not limited to being implemented in connection with the FRR procedure as defined in the various IEIF Internet-Drafts cited herein and incorporated herein by reference.

Those skilled in the art will further appreciate that the functions, procedures and services explained herein may be implemented using individual hardware circuitry, using software functioning in conjunction with a programmed microprocessor or general purpose computer, using an Application Specific Integrated circuit (ASIC) and/or using one or more Digital Signal Processors (DSPs). It will also be appreciated that while the present disclosure will partially be described in the form of methods and method aspects, it may also be embodied in a computer processor and a memory coupled to the processor, wherein the memory is encoded with one or more programs that cause the processor to perform the methods and method aspects disclosed herein.

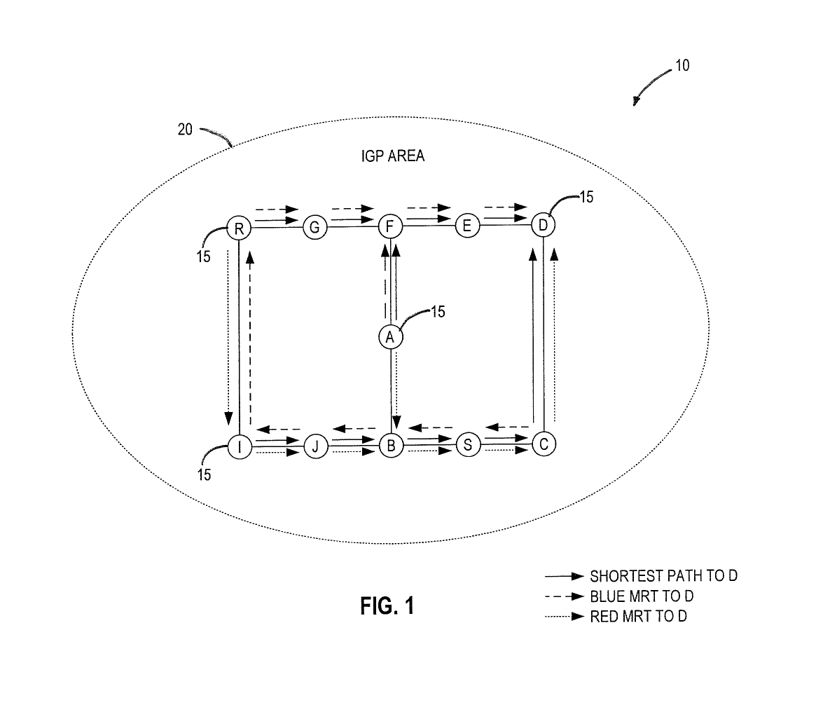

Often, a single MRT area is defined for an entire IGP area as illustrated in the example of FIG. 1. Because packets forwarded along the MRTs thus never leave the IGP area, it would be possible to keep MRT detours “local”, if the IGP areas could be selected arbitrarily, e.g., by keeping the IGP areas small. In many cases it is not possible to localize traffic in this way because the IGP areas are typically also selected based on other constraints. However, it has been found that there is no requirement that an MRT area must be co-extensive with the IGP area.

Thus, in exemplary embodiments of the present disclosure, two or more distinct MRT areas are defined for a set of connected network nodes, (e.g., IGP area or island), in a communication network. The connected network nodes can have the same MRT capabilities. Each MRT area comprises a subset of the set of connected network nodes. MRTs may then be defined independently for each MRT area. The MRTs in each MRT area provide protection for that MRT area as explained above.

The MRTs can be used to compute next-hops in the event of a failure along the shortest path. Computation of MRTs, endpoints of detours (if the endpoint is not the destination), and next-hops may be the same as the conventional case with a single MRT, except that a network node may be assigned to multiple MRT areas. Thus, a network node in embodiments of the present disclosure may compute detours for each MRT area including that network node.

In one exemplary embodiment of the present disclosure, a global MRT area within an IGP area is divided geographically (and/or topologically) into smaller MRT areas referred to herein as local MRT areas. MRTs may be defined for the global MRT area and each local MRT area. The local MRT areas may geographically (and/or topologically) be defined to keep traffic “local” in the event of a failure within that local MRT area. When a failure occurs in one of the local MRT areas, the network nodes in the local MRT area may attempt to use the local MRTs to circumvent the failure. Therefore, traffic diverted due to the failure can be handled locally. If the failure cannot be circumvented using the local MRTs, the network nodes in the local MRT may use the global MRTs. By introducing local MRTs based on the geographical (and/or topological) location of the network nodes, many failures can be handled locally to avoid congestion in remote parts of the IGP that would not otherwise be affected by the failure.

Aspects of the present disclosure relate generally to Fast Rerouting (FRR) procedures for packet-switched networks, such as Internet Protocol (IP) networks and Label Distribution Protocol (LDP) based Multiprotocol Label Switching (MPLS) networks. More particularly, aspects of the present disclosure relate to FRR using MRTs. As stated above, this does not rule out the possibility to implement the present disclosure in other procedures and other network types.

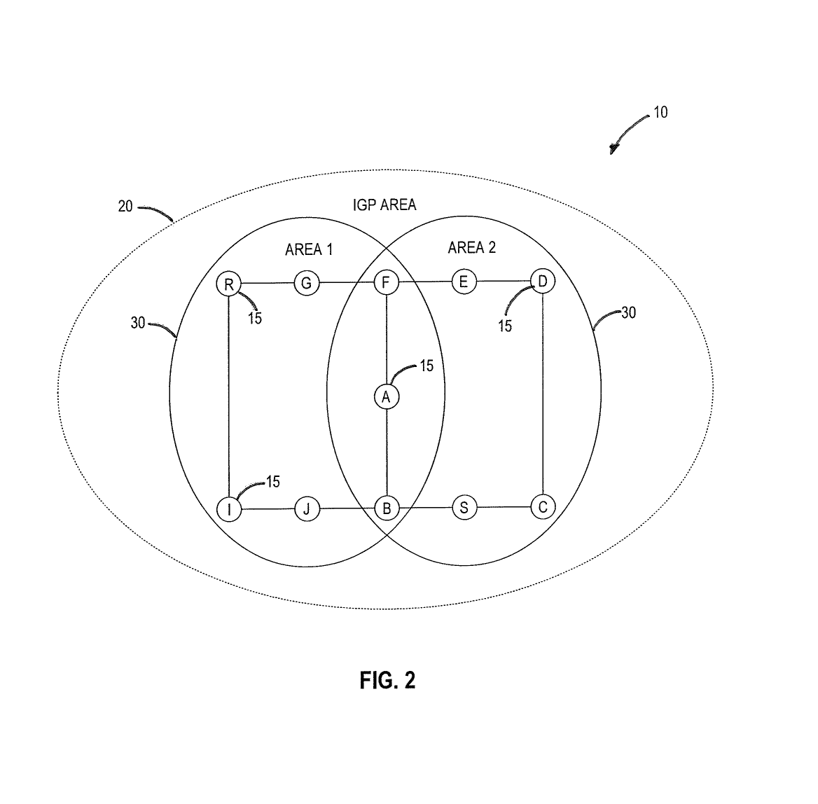

FIGS. 2 to 10 illustrate exemplary embodiments of the present disclosure. These embodiments are not intended to be limiting, but rather to provide simple examples of the techniques, in particular the FRR procedures, described herein. For convenience, similar reference numbers are used throughout the disclosure to indicate similar components.

As shown in FIG. 2, exemplary embodiments of the present disclosure, two or more distinct MRT areas 30 are defined for a set of connected network nodes 15, (e.g., IGP area 20 or island), in the communication network 10. The connected network nodes 15 in one variant have the same MRT capabilities. Each MRT area 30 comprises a subset of the set of connected network nodes. MRTs are defined independently for each MRT area 30. The MRTs in each MRT area 30 provide protection for that MRT area 30. The MRTs are used to compute next-hops in the event of a failure along the shortest path. Each network node 15 uses topology information (e.g., stored in a local link state database) for path computations. Computation of MRTs, endpoints of detours, and next-hops is the same as in the case with a single MRT, except that a network node 15 may be assigned to multiple MRT areas 30. Thus, a network node 15 in embodiments of the present disclosure computes detours for each MRT area 30 including that network node 15.

In some embodiments, an IGP area 20 may comprise multiple MRT islands. As used herein, the term “island” means a set (or subset) of connected network nodes 15. An MRT island means a set (or subset) of connected network nodes with the same MRT capabilities. MRT islands may be formed when the IGP area 20 includes legacy network nodes 15 lacking MRT capability. MRT islands may also be formed where two sets (or subsets) of connected network nodes support different MRT capabilities.

In connection with individual embodiments of this disclosure, two areas are considered disjoint for MRT purposes unless the areas support the same MRT capabilities even though a single network node 15 is contained in both areas. Where the IGP area 20 comprises multiple MRT islands, each MRT island may be handled separately, and multiple MRT areas 30 may be defined for each MRT island. If an MRT area 30 is split into two (or more) after a failure, the resulting disjoint areas can be handled as separate MRT areas 30 when the IGP area 20 has been reconfigured.

In one embodiment, that can be combined with other embodiments, the defined MRT areas 30 include a global MRT area 30 and one or more local MRT areas 30 that are defined to keep traffic “local” in the event of a failure within that local MRT area 30. The MRT areas 30 may be defined based on geographical location of the nodes, network topology information, or a combination thereof. When a failure occurs in one of the local MRT areas 30, the network nodes in the local MRT area 30 will attempt to use the local MRTs to circumvent the failure. Therefore, traffic diverted due to the failure will be handled locally. If the failure cannot be circumvented using the local MRTs, (e.g., the MRT area 30 is severed by the failure), the network nodes 15 in the local MRT area 30 may use the global MRTs for rerouting (e.g., FRR). By introducing local MRTs based on the geographical location of the network nodes 15, many failures can be handled locally to avoid congestion in remote parts of the network 10 that would not otherwise be affected by the failure.

When preparing for a failure, each network node s in an MRT area 30 may determine a detour endpoint d for each IP prefix p as it is done currently. Typically, the endpoint d for the detour is either the destination itself, or the last network node 15 in the area through which the packet leaves, (e.g., an area border router, ABR). In some cases (e.g., MRT islands or ABR protection) the detour endpoint may be some other network node 15. The endpoint selection may be performed using conventional methods and is not material to this disclosure.

Next, each node s checks whether there is an MRT area 30 both containing s and d. If so, the network node s pre-computes an FRR next-hop for d that avoids the potential failure (the default next-hop), using the MRTs in one of the defined MRT areas 30. It is possible that not all the MRT areas 30 are 2-connected. Thus, in one embodiment, that can be combined with other embodiments, s should select the MRT area 30 that provides the most protection. As an example, it should prefer node-protection to link protection, and any protection to no protection. In one embodiment, the network operator may define preferences.

MRT areas 30 can be defined arbitrarily by a network operator (e.g., via a suitably programmed computer or computer system); the only restriction is that the network nodes 15 in an MRT area 30 must be connected, otherwise it would be considered as two disjoint connected areas 30, (i.e., two islands). If the object is to keep detour traffic local, the network operator may define one or more geographical areas 30 to serve as local MRT areas 30 and then assign network nodes 15 to corresponding geographical areas 30 in which the network nodes 15 are located. It is possible that a network node 15 may belong to more than one geographical area 30. In other embodiments, the MRT areas 30 may be defined based on the network topology information. In this case, two network nodes that are connected by a link may be considered in the same MRT area 30 even though in a strict geographical sense, the network nodes 15 may be apart.

MRT areas 30 can be defined with different granularities. In the simplest case, it is possible to define which network node 15 belongs to which MRT area 30, and suppose that any link between two network nodes in the same area 30 belongs to that area 30 as well. In some cases, the network operator may want to exclude some links to protect against some certain failures. To accommodate the exclusion of certain nodes or links, it is possible to define the MRT areas 30 by defining the links/ports belonging to that MRT area 30. In this second case, a network node 15 s is belonging to area 30 x, if the network node 15 s has a link/port belonging to area 30x. It should be recognized that a link/port can belong to multiple areas 30. In all embodiments, MRT area information can be advertised by the IGP protocol, as is for the current version of MRT. MRT ineligible links (links that should not be used for MRT FRR) can be described easily too by not assigning those links to any MRT areas 30.

It is possible that the MRT areas 30 may overlap. Thus, a network node 15 receiving a packet on detour needs to know which MRT to use for forwarding. As previously described, two extra IP addresses or MPLS labels may be provided to indicate a pair of MRTs. Thus, in embodiments of the present disclosure, each network node 15 will have two extra IP addresses or MPLS labels for each MRT area 30 to which the network node 15 is assigned. The network nodes 15 can thus determine when a packet is on a detour based on the IP address or MPLS label.

FIG. 2 illustrates an exemplary network 10 wherein an IGP area 20 is divided into multiple MRT areas 30. The network 10 comprises eleven network nodes 15 arranged in two rings. Nodes A, B, and F are common to both rings. The network 10 shown in FIG. 2 is the same as the network 10 shown in FIG. 1 but, instead of having a single MRT area 30 that covers the entire IGP area, two distinct MRT areas 30 are defined. Each MRT area 30 encompasses a distinct subset the network nodes 15 in the IGP area 20. In this example, the MRT area 30 denoted as Area 1 encompasses the ring R-I-J-B-A-F-G and the MRT area 30 denoted as Area 2 encompasses the ring D-C-S-B-A-F-E.

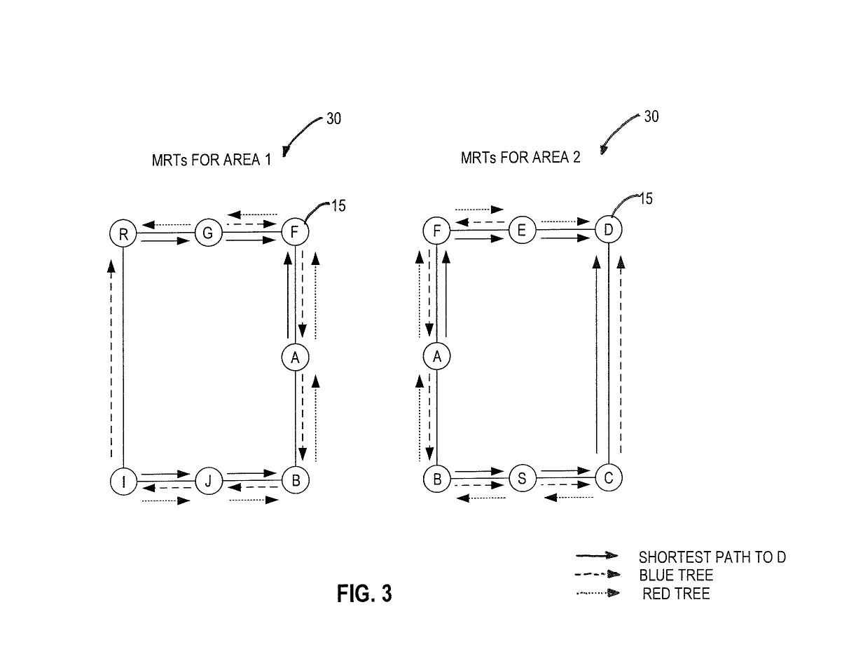

FIG. 3 illustrates an exemplary pair MRTs for each of the MRT areas 30. The MRTs for Area 1 are rooted at Node R and the MRT pairs for Area 2 are rooted at Node D. It should be understood that each MRT area 30 may have additional MRTs not shown rooted at different network nodes 15. Thus, multiple MRT pairs may be defined in each MRT area 30, where the computation of each MRT pair assumes a different root node. Assuming the same failure scenario as before, if the link between Node C and Node D fails, Node S can reroute packets along the red tree for Area 2 to Node D. The path to Node D defined by the red tree is B-A-F-E-D. Compared to the example shown in FIG. 1, the detour is shorter and the geographical range of the detoured packets is smaller. Thus, the techniques described herein may be used to limit how far detoured packets may range from the point of the failure.

In one exemplary embodiment of the present disclosure, a global MRT area 30 may be defined containing all the MRT-capable network nodes 15 in an IGP area 20, excluding only those links, which must never be used for rerouting (these links can be defined, e.g., by the operator). One or more smaller MRT areas 30, referred to herein as local MRT areas 30, can be defined within the global MRT area 30. For example, a local MRT area 30 may be defined for each city in the global MRT area 30. When there is a failure, and both the point of local repair (PLR) and detour destination are in the same local MRT area 30, the MRTs for the local MRT area 30 could be selected. In this embodiment, the global MRT area 30 encompassing the whole IGP area 20 is used for failures that cannot be handled locally.

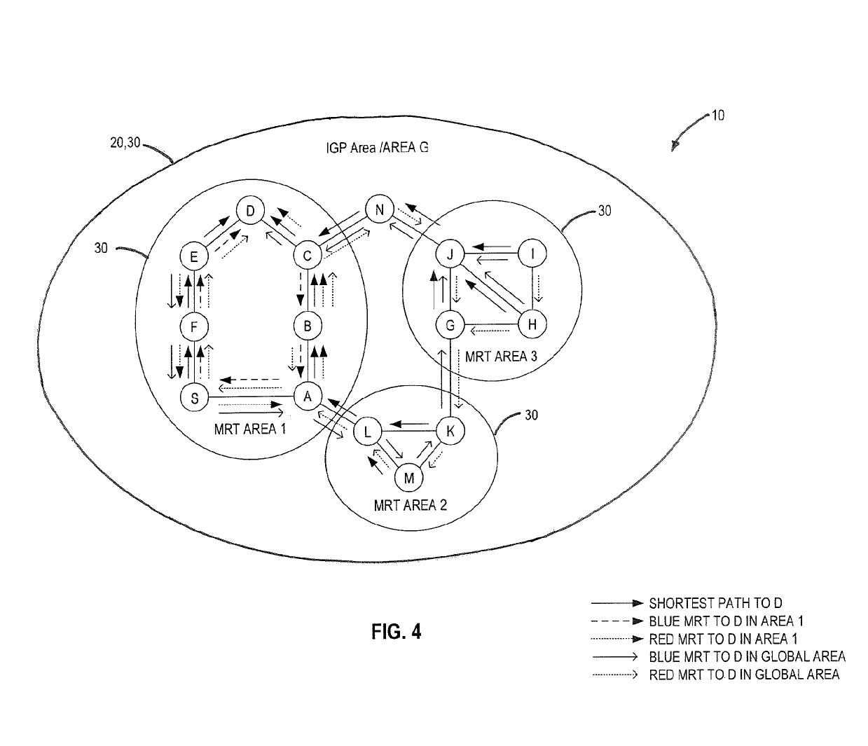

FIG. 4 illustrates a network 10 having both global and local MRT areas 30 within an IGP area 20. The IGP area 20 in this example comprises fifteen network nodes 15. A global MRT area 30, denoted Area G, comprising all MRT-capable network nodes 15 in the IGP area 20 is defined. Three local MRT areas 30, denoted as Areas 1-3, are also defined and encompass subsets of the network nodes 15 in smaller geographical areas. The geographical areas may be defined by the network operator. Note that Node N is not contained within any local MRT area 30, but is contained within the global MRT area 30.

A shortest path tree is defined for Node D, which is used for default forwarding (it was supposed that link costs are uniform). Moreover, MRTs are computed as well for all the areas. Since Node D is in two areas (Area G and Area 1) there will be two pair of MRTs having Node D as a root. These four trees are depicted in FIG. 4. It should be appreciated that there are other MRTs for other network nodes 15 not depicted. When a network node 15 in Area 1, let that Node S, wants to send packets to Node D, but it faces a failure on the shortest path (e.g., F goes down), it can use either the global pair of trees or the pair of Area 1. If it prefers the MRTs of Area 1, it can use is the red MRT in Area 1 and packets will easily reach the destination without leaving Area 1. However, if Node S is using the blue tree rooted at Node D in Area G, the packets would still reach Node D, but on a much longer path. The global MRT area 30 is needed for network nodes 15 that are not in Area 1. For example, if Node N goes down Node 3 sending packets to Node D must use the red tree in the global area.

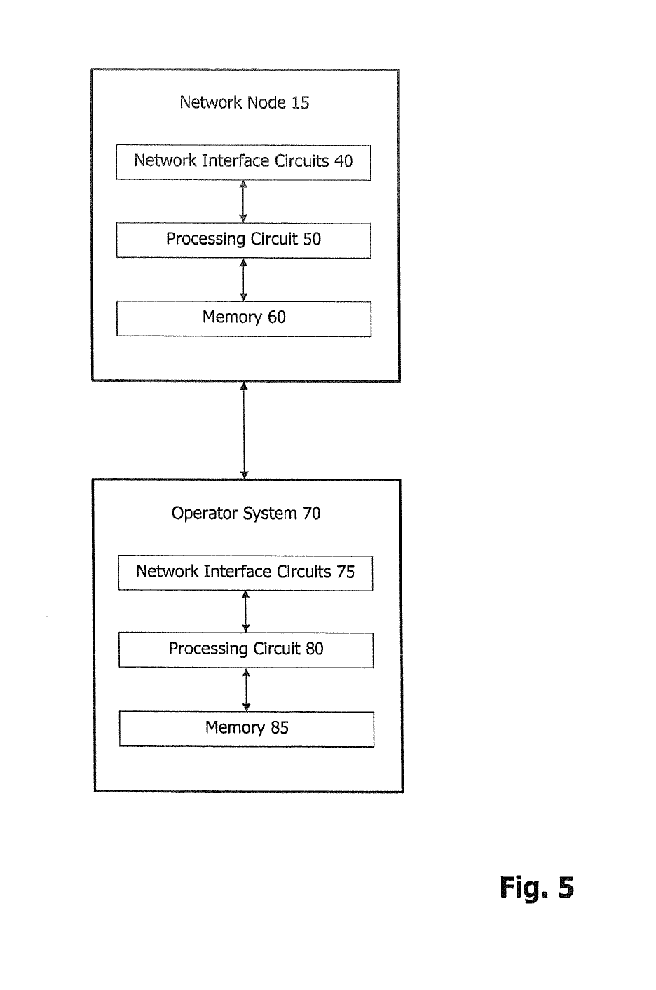

FIG. 5 illustrates the configuration of a network node 15 as well as of an operator system 70 according to embodiments of the present disclosure. The network node 15 and the operator system 70 may be configured to perform any of the methods and procedures presented herein.

The network node 15 comprises network interface circuits 40, a processing circuits 50, and memory 60. The network interface circuits 40 comprise circuitry for connecting to the communication network 10 and, optionally, to the operator system 70. The processing circuit 50 comprise one or more processors, hardware circuits, firmware, or a combination thereof, configured to implement the methods and procedures as herein described. Memory 60 comprises devices for storing program instructions executed by the processing circuit 50 and/or data needed for operation. The data stored may include, for example, data structures such as routing tables, link state database for path computations, MRTs, endpoints, etc.

In a similar manner, the operator system 70 (e.g., a computer or computer system) comprises network interface circuits 75, a processing circuit 80, and a memory 85. The network interface circuits 75 comprise circuitry for connecting to the communication network 10, including the network node(s) 15. The processing circuit 80 comprises one or more processors, hardware circuits, firmware, or a combination thereof, configured to implement the methods and procedures as herein described. Memory 85 comprises devices for storing program instructions executed by the processing circuit 50 and/or data needed for operation. The data may be stored in a database. The data may comprise at least one of geographical and topological information pertaining to the network 10 and the network nodes 15 in the network 10.

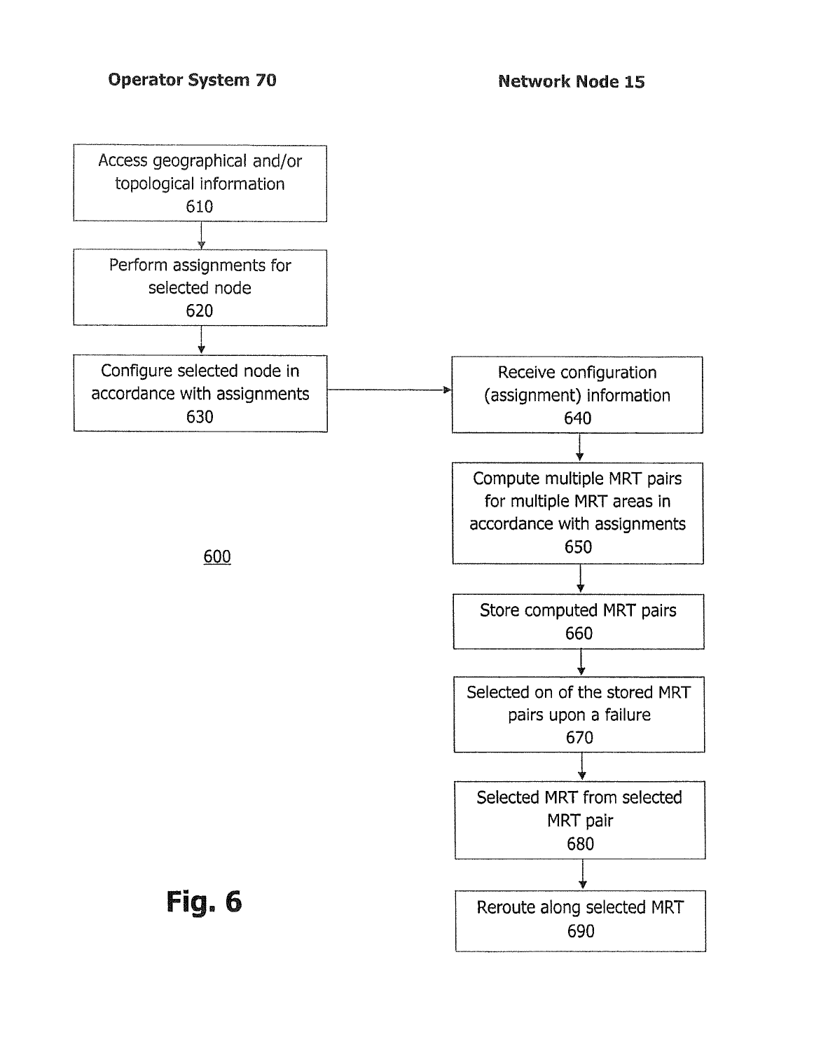

In the following the operations of the operator system 70 and the network node 15 will be described in more detail with reference to the exemplary flow diagram 600 of FIG. 6. The flow diagram 600 illustrates method embodiments performed by the operator system 70 and the network node 15.

The procedure illustrated in FIG. 6 starts with the processing circuit 80 of the operator system 70 accessing memory 85 to retrieve geographical and/or topological information pertaining to the network 10 and the network nodes 15 included therein (step 610). The processing circuit 80 processes the retrieved information and selects individual ones of the network nodes 15 for assigning each selected node 15 to one or multiple MRT areas 30 as generally described and illustrated herein (step 620). One or more of the selected nodes 15 will be assigned to multiple MRT areas 30. Each individual MRT area 30 comprises a particular subset of the set of connected nodes within the network 10.

In a further step 630, each selected node 15 is configured by the operator system 70 in accordance with the assignments performed in step 620. To this end, configuration information may be provided to the node 15 as illustrated in FIG. 6. The configuration information will be indicative of the assignments performed in step 620. As an example that will be discussed in more detail below, the configuration information may be provided to the node 15 in form of an individual MRT profile or an individual profile ID per MRT area 30 to which the node 15 is assigned.

The configuration information is received by the node 15 in step 640. The configuration information may be received via the network interface circuits 40 of the node 15 (from the corresponding network interface circuits 75 of the operator system) or in any other way. As an example, the configuration information may also be provided to the node 15 via an operator setting.

In a further step 650, the processing circuit 50 of the mode 15 computes multiple MRT pairs for multiple MRT areas 30 to which the node 15 is assigned. As an example, an individual MRT pair may be computed for each profile ID that has been signalled to the node 15 via the configuration information.

In another step 660, the computed MRT pairs are stored in memory 60. Once the MRT pairs have been stored, the node 15 has been prepared (e.g., enabled) for packet rerouting upon a node or a link failure in the network 10.

Once a failure has occurred, the node 15 selects one of the stored MRT pairs in step 670. Various strategies that may be applied in connection with selection step 670 are described herein. As an example, the selection may be based on a local/global paradigm, according to which the node 15 primarily tries to select an MRT pair for local rerouting.

Then, in step 680, an individual MRT is selected from the MRT pair that has been selected in step 650. The selection in step 680 may be performed in accordance with the IETF documentation, or otherwise.

Once an individual MRT has been selected in a step 680, the selected MRT is used for rerouting (step 690). The rerouting along the selected MRT may be performed until the network 10 has been reconfigured. After the reconfiguration, the routing may again occur via the shortest path as described herein.

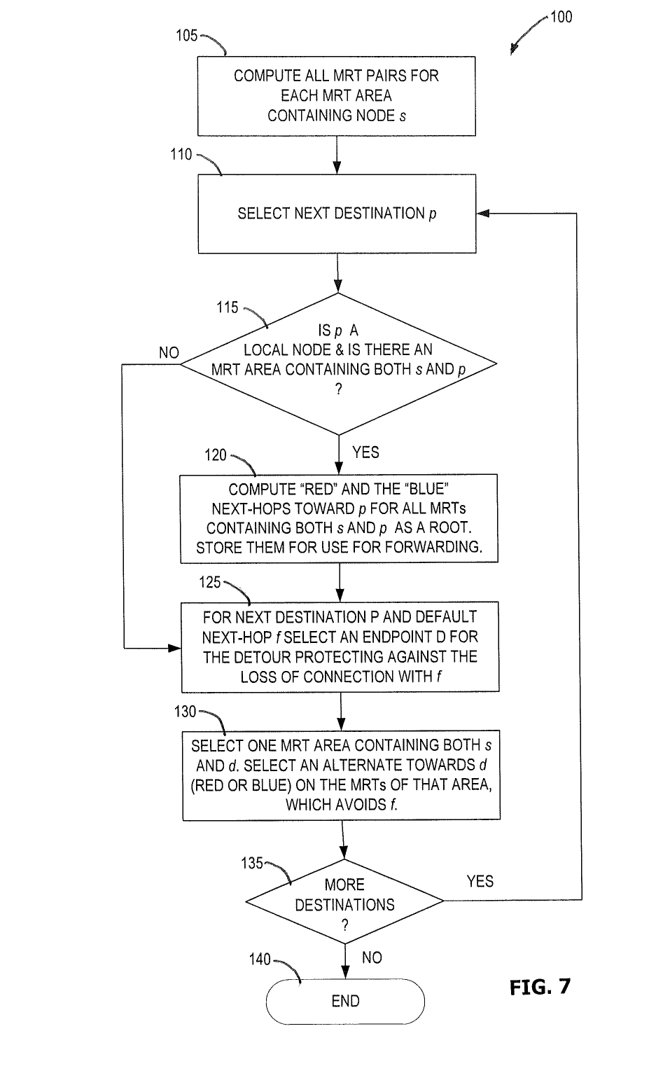

FIG. 7 illustrates a more detailed embodiment of a method represented by flow diagram 100 and implemented by network node s (see reference numeral 15 in FIGS. 2, 3 and 4). The method computes in a packet-switched network detours for FRR using MRTs. The method of FIG. 6 may be performed in connection with the more general scenario shown in FIG. 5.

At step 105, the network node s computes all possible MRT pairs for each MRT area 30 containing node s (i.e., for each MRT area 30 to which the node s is assigned, see step 650 is FIG. 6). Each network node in the MRT area may be assumed as a root node. The MRT pairs per MRT area 30 may be stored in memory 60.

The network node s then selects the destination p from a list of destinations (step 110). For IP networks, the destination p is identified by an IP prefix. In MPLS networks, the destination is a path endpoint.

In step 115, the network node s determines whether the destination p is a local node in the network 10 and whether there is an MRT area 30 containing both s and p. If both these conditions are satisfied, the network node s computes the next hops towards p along both the red and blue trees for all MRTs containing both s and p as a root (step 120). These next hops are stored in a routing table for use in forwarding (e.g., in memory 60).

The network node s then performs endpoint selection for fast rerouting. For each destination p and default next hop f, network node s selects an endpoint d for a detour protecting against the loss of a connection with f (step 125). Once the endpoint d is determined, the network node s selects an alternate route towards d on one of the MRTs for the selected area which avoids f (step 130).

Once the alternate route is selected, the network node s determines if there are more destinations (step 135). If so, the process steps 110 through 130 are repeated until the last destination p is processed. The procedure then ends (step 140).

The use of a global MRT area 30 has the advantage that any failure can be corrected regardless of the destination (as long as the failure is not splitting the area into two).

Note that network node s may be a member of multiple IGP areas. In that case, the network node s will perform the previous procedure for each of its IGP areas separately.

MRT areas 30 can be realized using MRT profiles. MRT profiles are currently used to advertise the capabilities of network nodes 15, see IETF document [I-D.atlas-osfp-mrt] incorporated herein by reference. A set of MRT-capable network nodes 15 supporting the same MRT profile can form an MRT island. MRT islands supporting different MRT profiles are viewed for MRT purposes as mutually exclusive sets of connected network nodes 20.

While MRT profiles are originally intended to advertise MRT capabilities, it is possible to define multiple MRT profiles for a network node 15 in accordance with IETF document [I-D.atlas-osfp-mrt]. These MRT profiles advertise the same capabilities and differ only in the profile ID. The profile ID thus artificially defines an MRT island that is not based on the capabilities of the network node. It should be noted that MRT profiles with the same profile ID should support the same MRT capabilities.

The techniques presented herein may be used to create artificial MRT islands based on, for example, the geographical locations of the network nodes 15. While MRT profiles may be used to create MRT islands in accordance with IETF document [I-D.atlas-osfp-mrt], those skilled in the art will recognize that other techniques may also be used.

The following embodiments provide additional details for implementing FRR based on artificial MRT areas (in the form of MRT islands). These embodiments particularly relate to the procedures defined in the IETF documentation and may be combined with any of the embodiments described above.

IP and LDP FRR using MRTs is defined in IETF document [I-D.ietf-rtgwg-mrt-frr-architecture], incorporated herein by reference. The following embodiments add a simple extension to that technique, which can guarantee to keep detours local (i.e., in the part of the network, where the failure happened).

In the case of failure, Fast Reroute using Maximally Redundant Trees (MRT-FRR), as defined in IETF document [I-D.ietf-rtgwg-mrt-frr-architecture], use detours defined by two maximally redundant trees, which are not related to shortest paths at all. As explained above, although there are heuristics for decreasing path lengths, which are sufficient in almost all situations, there is no strict guarantee to keep failure handling local. This means that detours may cause temporal congestion even in those parts of the network, which are far from the original failure.

The techniques presented herein define a possible solution by using MRTs in an IGP area. The techniques introduce artificial areas (or “subareas”), each having its own recovery, and use them to provide the best possible protection. If both the PLR and the destination are in the same area/subarea, the detour can simply use one of the trees of that area/subarea, in this way never leaving the surroundings of the failure.

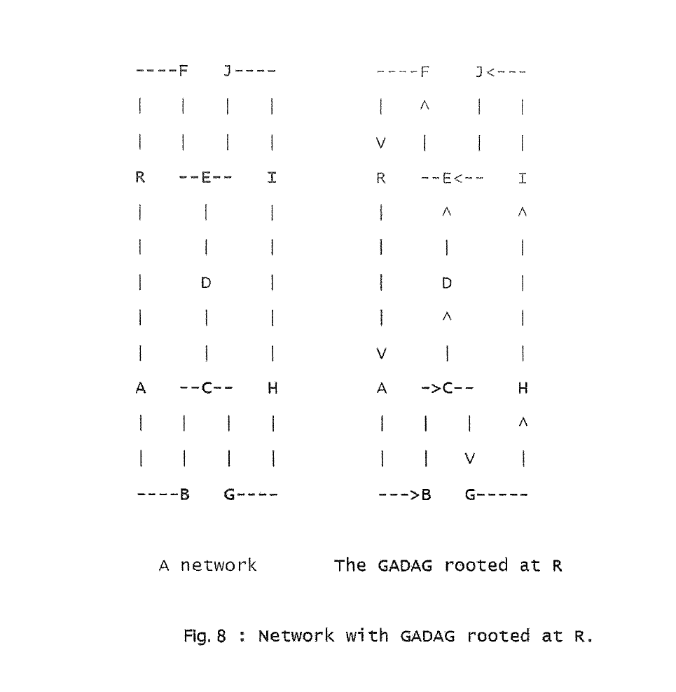

Consider the network and GADAG depicted in FIG. 8 (for GADAG computation and finding FRR paths using a GADAG consult the IETF document [I-D.enyedirtgwg-mrt-frr-algorithm], incorporated herein by reference). Suppose that Node H wants to send some packets to node I, but the link between them went down. Since Node H is definitely lesser than Node I, the detour must be the one that goes through Node R, (i.e., H->G->C->B->A->R->F->E->J->I), even if there was a much shorter one through Node D. The problem also here is not that such path is long, but that the traffic may get far away from the failure, thus congestion may occur in any part of the network.

There are already possibilities to mitigate the problem presented above. First, there are heuristics that can be applied in order to decrease path lengths, thus paths in real networks are usually using detours not much longer than the shortest paths. Even when heuristics cannot help (like in the network of FIG. 8), there is still some room for optimization by selecting the GADAG root better. For instance, in the previous example, selecting Node D as a GADAG root can solve the problem (however it cannot solve anything if one adds one more ring connected to Node A and Node R). Finally, it should be noted that congestion can be caused only while IGP is doing the recovery, which is quite fast in most of the cases, in this way reducing the severity of this situation. As said, the present disclosure describes a mechanism to give strict guarantees that detour does not get far from the failure. This can be applied for special situations, when detours would be too long otherwise or in networks, where bandwidth guarantees are needed to be fulfilled in all cases.

The concept of artificial islands will be described next. MRT-FRR capable routers can handle multiple MRT profiles. MRT profiles were introduced for handling routers with different capabilities, (even those which do not support MRT-FRR at all). Routers supporting the same profile create an MRT-FRR island in the IGP area.

Each such island has its GADAG and its own redundant trees, which are only valid in that island. If a packet gets out from an island, it gets back to the shortest path. If the destination (or the area/AS border router) is inside the island where the failure happened, it is guaranteed that packet will never leave the island. Basically, islands are (sub)areas with their own protection.

Conventionally, islands are there only for handling capability differences between routers. The present disclosure introduces artificial islands which are limiting packet detours to a part of the network. In order to define such an island, a network operator needs only to configure routers in the desired subarea to advertise one more profile, which is not supported by any other router in the network. As explained above, this profile does not need to describe new capabilities, but it can differ from other profiles just in some extra ID field. Therefore, a profile descriptor may be extended with such ID field.

Network operators may define islands arbitrarily; the only restriction is that such islands must be connected, otherwise they would be considered as multiple connected islands. Similarly, if an island is split into disjunct parts due to some failure, such parts can be handled as disjunct islands. As an example, operators can define one island containing the whole IGP area, and some smaller ones for keeping up local failure handled when needed. When a failure can be handled locally, a “small” island is used, while there is still the “big” island containing the whole area for the remaining cases.

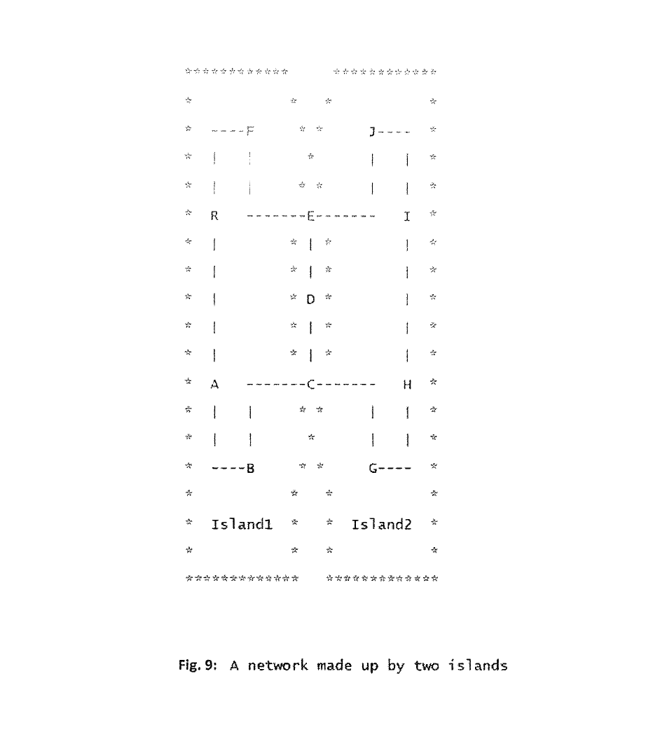

As an example of this scheme, consider the network of FIG. 8, and define artificial islands in it in order to keep packets inside the ring where the failure has happened. The network and the two islands defined are depicted in FIG. 9. Note that there should be a third island that contains all the nodes to handle failures that cannot be handled locally; this third island is not depicted in FIG. 9. Also note that having this third island is not mandatory, it can be not configured, if operator wants to disable global protection for some reason.

Observe that Island1 and Island2 are not disjunct, instead both of them are containing Nodes C, D and E, in this way making both islands 2-connected. This overlap is the main difference compared to the situation when an area is split into two using MRT-ineligible links; if one would only disable the MRT capability for some links in this network, at least one of the resulting “(sub)areas” (islands) would be not 2-connected, thus protection would be impossible in at least one of them. Moreover thanks to overlapping, it is possible to define the third island and use it to provide protection when the PLR and the destination are not in the same ring (i.e., when there is no local detour).

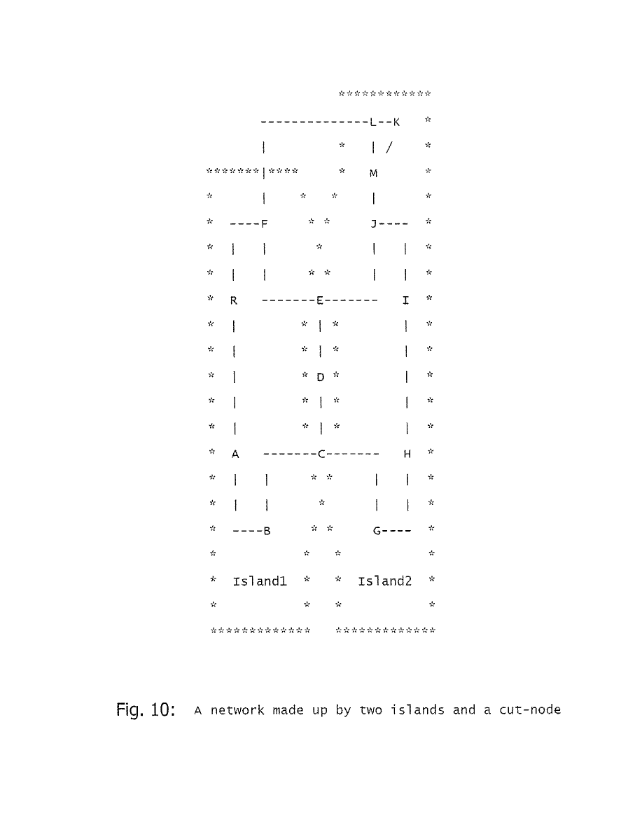

Although it is useful for protection, note that network operators do not always need to find 2-connected artificial islands, if there are considerations other than maximum protection. Consider FIG. 10 and suppose that in this network link L-F is not wanted to be used for local protection for some reason. In this case, the two artificial islands for local protection are selected as depicted in FIG. 10. If Node M is going down, Island2 is split into two, so no local protection is possible in this case. (Naturally, selecting Island2 is not pointless, if any link or any other node than Node M is going down, there is still local protection.)

If a router is in multiple islands, selecting one for a concrete failure case is a local decision of the node. Vendors may make it possible to assign priority at each router for the artificial islands created. Moreover, routers may take other differences into consideration as well, (e.g., if there is node protecting path in one island but only link protecting in another one).

Selecting the endpoint of detour is a local decision of MRT-FRR capable routers, it is not needed to select always the destination/border router as the endpoint, especially when not all the routers are supporting MRT-FRR and islands are formed (for details see the IETF document [I-D.ietf-rtgwg-mrt-frr-architecture]). If there are artificial islands the only difference is that a router may belong to multiple islands, so it may take into consideration all of those islands and select the best for that failure with respect to arbitrary local preference.

For MRT-FRR, each router may have two extra addresses/labels per profile it supports (as explained above). The situation is the same if there are artificial islands applied, since a router in multiple islands computes the MRTs for each of those islands, and it will be able to decide which of these trees is used.

It is believed that the advantages of the technique presented herein will be fully understood from the foregoing description, and it will be apparent that various changes may be made to the form, construction and arrangement of the exemplary aspects thereof without departing from the scope of the claims appended hereto.

### FRR REFERENCES

[I-D.enyedi-rtgwg-mrt-frr-algorithm]
Envedi, G., Csaszar, A., Atlas, A., cbowers@juniper.net,
C. and A. Gopalan, “Algorithms for computing Maximally Redundant Trees for IP/LDP Fast-Reroute”, Internet-Draft draft-enyedi-rtgwg-mrt-frr-algorithm-03, July 2013.
[I-D.ietf-rtgwg-mrt-frr-architecture]
Atlas, A., Kebler, R., Envedi, G., Csaszar, A., Tantsura, J., Konstantynowicz, M. and R. White, “An Architecture for IP/LDP Fast-Reroute Using Maximally Redundant Trees”, Internet-Draft draft-ietf-rtgwg-mrt-frr-architecture-03, July 2013.
[I-D.atlas-osfp-mrt]
Atlas, A. Hedge, S., Chris, C., and J. Tantsura, “OSFP Extensions to Support Maximally Redundant Trees”, draft-atlas-ospf-mrt-00 (work in progress), July 2013

### DEFINITIONS FOR EXEMPLARY FRR EMBODIMENTS

Maximally Redundant Trees (MRT): A pair of trees where the path from any node X to the root R along the first tree and the path from the same node X to the root along the second tree share the minimum number of nodes and the minimum number of links. Each such shared node is a cut-node. Any shared links are cut-links.

2-connected: A graph that has no cut-nodes. This is a graph that requires at least two nodes to be removed before gets partitioned.

block: Either a maximally 2-connected (induced) subgraph, a cut-link with its endpoints, or an isolated node.

DAG: Directed Acyclic Graph—a digraph containing no directed cycle.

ADAG: Almost Directed Acyclic Graph—a digraph that can be transformed into a DAG with removing a single node (the root node).

GADAG: Generalized ADAG—a digraph, which has only ADAGs as all of its blocks.

PLR: Point of Local Repair—the node neighboring the failed resource (which can be a node or a link), and which do the rerouting.

Cut-node: A node is a cut-node, if removing it partitions the network.

Cut-link: A link is a cut-link, if removing it partitions the network.

1-26. (canceled)

27. A method for preparing a node in a packet-switched communication network for enabling packet rerouting upon a failure, wherein the node belongs to a set of connected nodes in the network and wherein the rerouting occurs along a detour defined by a Multiple Redundant Tree (MRT), the method being performed by the node and comprising:
computing at least one first MRT pair for a first MRT area to which the node is assigned, wherein the first MRT area comprises a first subset of the set of connected nodes; and
computing at least one second MRT pair for a second MRT area to which the node is assigned, wherein the second MRT area comprises a second subset of the set of connected nodes.

28. The method of claim 27, wherein the method further comprises, prior to the computing steps, receiving configuration information from an operator system, the configuration information being indicative of assignments of one or more selected individual ones of the nodes to one or multiple of the MRT areas.

29. The method of claim 27, wherein the first MRT area and the second MRT area overlap at least partially.

30. The method of claim 27, wherein the second subset corresponds to the set of connected nodes.

31. The method of claim 27, further comprising selecting, upon a failure, one of the first MRT pair and the second MRT pair.

32. The method of claim 31, wherein the second subset corresponds to the set of connected nodes and wherein, upon a failure in the first MRT area, the first MRT pair is selected.

33. The method of claim 32, wherein the second MRT pair is selected in response to determining that the failure cannot be circumvented using the first MRT pair.

34. The method of claim 27, wherein the second subset fully comprises the first subset and at least a third subset of the set of connected nodes, and wherein the method further comprises computing at least one third MRT pair for a third MRT area comprising the third subset, wherein the third subset is constituted by one, more or all of the remaining nodes of the set of connected nodes.

35. The method of claim 34 further comprising at least one of:
selecting, upon a failure in the first MRT area or the second MRT area, the first MRT pair or the second MRT pair, respectively; and
if a failure in the first MRT area or the second MRT area cannot be circumvented using the respective MRT pair, selecting the third MRT pair.

36. The method of claim 27, wherein the set of connected nodes is defined by one of:
an Interior Gateway Protocol (IGP) area; and
an MRT island.

37. The method of claim 27, wherein at least one of the first MRT area and the second MRT area is defined by at least one of:
geographical locations of the connected nodes; and
network topology information pertaining to the connected nodes.

38. The method of claim 37, wherein at least one of the first MRT area and the second MRT area is defined to handle failures locally.

39. The method of claim 27, further comprising advertising MRT area information using at least one of the Interior Gateway Protocol (IGP) and MRT profiles.

40. The method of claim 39, wherein the MRT area profiles for the first MRT area and the second MRT area, respectively, advertise the same MRT capabilities and different profile identifiers.

41. The method of claim 27, wherein the node maintains one of two dedicated Internet Protocol (IP) addresses and two dedicated Multi-Protocol Label Switching (MPLS) labels for each MRT area to which it is assigned.

42. A method of assigning nodes in a packet-switched communication network to Multiple Redundant Tree (MRT) areas for enabling packet rerouting upon a failure, wherein the nodes belong to a set of connected nodes in the network and wherein the rerouting occurs along detours defined by MRTs, the method being performed in an operator system and comprising:
assigning a node to a first MRT area, wherein the first MRT area comprises a first subset of the set of connected nodes; and
assigning the node to a second MRT area, wherein the second MRT area comprises a second subset of the set of connected nodes.

43. The method of claim 42, wherein the assigning is performed based on at least one of:
geographical locations of the connected nodes; and
network topology information pertaining to the connected nodes.

44. The method of claim 42, further comprising
configuring the node for advertising MRT area information using at least one of the Interior Gateway Protocol (IGP) and MRT profiles.

45. The method of claim 44, wherein the node is configured so that the MRT area profiles for the first MRT area and the second MRT area, respectively, advertise the same MRT capabilities and different profile identifiers.

46. A node in a packet-switched communication network that is enabled for packet rerouting upon a failure, wherein the node belongs to a set of connected nodes in the network and wherein the rerouting occurs along a detour defined by a Multiple Redundant Tree (MRT) the node comprising at least one processor configured to:
compute at least one first MRT pair for a first MRT area to which the node is assigned, wherein the first MRT area comprises a first subset of the set of connected nodes;
compute at least one second MRT pair for a second MRT area to which the node is assigned, wherein the second MRT area comprises a second subset of the set of connected nodes.

47. An operator system for assigning nodes in a packet-switched communication network to Multiple Redundant Tree (MRT) areas for enabling packet rerouting upon a failure, wherein the nodes belong to a set of connected nodes in the network and wherein the rerouting occurs along detours defined by MRTs, the operator system being configured to:
assign a node to a first MRT area, wherein the first MRT area comprises a first subset of the set of connected nodes; and
assign the node to a second MRT area, wherein the second MRT area comprises a second subset of the set of connected nodes.
